(19) United States
(12) Patent Application Publication
(10) Pub. No.: US 2021/0307116 A1
(43) Pub. Date: Sep. 30, 2021

(54) SMOKE GENERATOR

(71) Applicant: ShenZhen AUTOOL Technology Co., Ltd., Shenzhen (CN)

(72) Inventor: Xiangyang Xiong, Shenzhen (CN)

(73) Assignee: ShenZhen AUTOOL Technology Co., Ltd.

(21) Appl. No.: 17/343,747

(22) Filed: Jun. 10, 2021

(30) Foreign Application Priority Data
May 12, 2021 (CN) 202121017610.4

(51) Int. Cl. H05B 3/06

(52) U.S. Cl. CPC H05B 3/06; H05B 2203/016; H05B 2203/002

(57) ABSTRACT

Disclosed is a smoke generator. The smoke generator comprises a shell, conductive columns, a heating resistance wire and cellucotton, wherein the conductive columns are connected with the heating resistance wire, and the cellucotton is in contact with the heating resistance wire; an accommodating cavity is formed in the shell, and the cellucotton is placed in the accommodating cavity; a liquid input port, a gas inlet and a smoke outlet are formed in the shell, and the liquid input port, the gas inlet and the smoke outlet communicate with the accommodating cavity. The smoke generator has the advantages of simple structure, compact matching, reasonable design and the like; and therefore, the smoke generator is a product with excellent technical performance and economical performance.

### TECHNICAL FIELD

The present disclosure mainly relates to a smoke generator.

### BACKGROUND

With the advent of smoke generators, the market presents a challenge for the equipment to be compatible with various working conditions and oil products. Traditional equipment supplies oil through spraying or gap siphon, and has special requirements for purity, viscosity and particle precipitates of oil products, otherwise, equipment failure is directly caused, and the application range of the equipment is greatly limited.

### SUMMARY

Aiming at the disadvantages in the prior art, a scheme of a smoke generator which can realize automatic filtration and can be compatible with various liquid oils and fats with combustible characteristics and related compounds as raw materials is developed, and the smoke generator adopts the following technical scheme:

The smoke generator comprises a shell, conductive columns, a heating resistance wire and cellucotton, the conductive columns are connected with the heating resistance wire, and the cellucotton is in contact with the heating resistance wire;

an accommodating cavity is formed in the shell, and the cellucotton is placed in the accommodating cavity; and a liquid input port, a gas inlet and a smoke outlet are formed in the shell, and the liquid input port, the gas inlet and the smoke outlet communicate with the accommodating cavity.

Preferably, the shell is internally provided with a liquid level identification line.

Preferably, the conductive columns comprise a first conductive column and a second conductive column, and the two ends of the heating resistance wire are respectively connected to the first conductive column and the second conductive column.

Preferably, the cellucotton is vertically arranged along the accommodating cavity.

Preferably, the length of the first conductive column is greater than that of the second conductive column.

Preferably, the heating resistance wire is spirally wound on the cellucotton.

Compared with the background art, the present disclosure has the following beneficial effects:

By adopting the scheme, smoke generating liquid which is not higher than the liquid level identification line is added from the liquid input port, and the smoke generating liquid is permeated and ascended to the top end of the cellucotton through adsorption of a capillary phenomenon. Voltage is respectively introduced into the first conductive column and the second conductive column, and the first conductive column and the second conductive column are matched with the heating resistance wire to form a loop, so that the heating wire connected to the conductive columns is electrified and heated; under the action of the heating wire, the smoke generating liquid is heated to a boiling point temperature, so that physical and chemical reactions are carried out to generate smoke; the liquid input port is closed, and generated smoke is discharged from the smoke outlet by adding certain pressure to the gas inlet. This scheme is applicable to a wide range of raw materials. Any liquid fuel that can generate smoke in industry can be used as smoke generating liquid.

### BRIEF DESCRIPTION OF THE DRAWINGS

FIG. 1 is a structural schematic diagram of a smoke generator in a preferred embodiment provided by the present disclosure.

### DESCRIPTION OF THE EMBODIMENTS

Embodiments of the present disclosure are described in detail below, and examples of the embodiments are illustrated in the attached FIGURES, wherein same or similar mark numbers refer to the same or similar elements or elements with the same or similar function throughout.

In the present disclosure, unless otherwise expressly stated and limited, the terms such as “install”, “link” and “connect” should be generally understood, for example, the components can be fixedly connected, and also can be detachably connected or integrally connected; the components can be mechanically connected, and also can be electrically connected; the components can be directly connected, also can be indirectly connected through an intermediate, and can be communicated internally. For those skilled in the art, the specific meanings of the terms in the present disclosure can be understood according to specific conditions.

In combination with the attached FIGURES in the present disclosure, the specific implementation mode of the present disclosure is further described, so that the technical scheme and the beneficial effects of the present disclosure are clearer and more definite. The embodiments described below by reference to the attached FIGURES are exemplary only for explaining the present disclosure and are not to be construed as limiting the present disclosure.

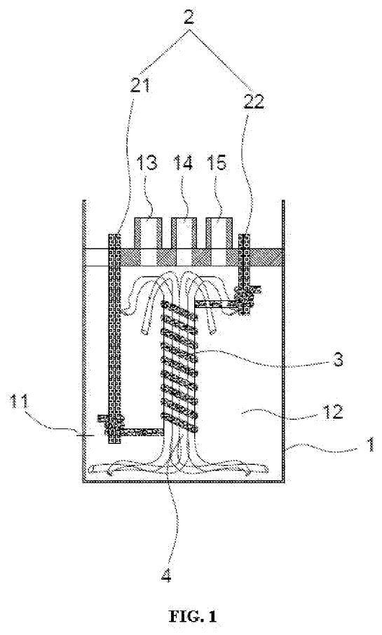

In a preferred embodiment provided by the present disclosure, as shown in FIG. 1, a smoke generator comprises a shell 1, conductive columns 2, a heating resistance wire 3 and cellucotton 4, the conductive columns 2 are connected with the heating resistance wire 3, and the cellucotton 4 is in contact with the heating resistance wire 3; and the shell 2 is provided with a liquid level identification line 11.

An accommodating cavity 12 is formed in the shell 1, and the cellucotton 4 is placed in the accommodating cavity 12; the cellucotton 4 is vertically arranged upwards along the accommodating cavity, so that smoke generating liquid is permeated and ascended through adsorption of the cellucotton, and large-particle substances are isolated at the bottom of the accommodating cavity to realize a filtering capability; and a liquid input port 13, a gas inlet 14 and a smoke outlet 15 are formed in the shell 1, and the liquid input port 13, the gas inlet 14 and the smoke outlet 15 communicate with the accommodating cavity 12.

The conductive columns 2 comprise a first conductive column 21 and a second conductive column 22, and the first conductive column 21 and the second conductive column 22 are a positive electrode conductive column and a negative electrode conductive column. The heating resistance wire 3 is spirally wound on the cellucotton 4 to increase the contact area of the heating resistance wire and the cellucotton, the used cellucotton is uniformly heated, and the smoke generating speed is increased. The two ends of the heating resistance wire 3 are respectively connected to the first conductive column 21 and the second conductive column, and the length of the first conductive column 21 is greater than that of the second conductive column 22 to match with the vertically arranged cellucotton.

When in use, smoke generating liquid which is not higher than the liquid level identification line is added from the liquid input port, and the smoke generating liquid is permeated and ascended to the top end of the cellucotton through the adsorption of a capillary phenomenon. Voltage is respectively introduced into the first conductive column and the second conductive column, and the first conductive column and the second conductive column are matched with the heating resistance wire to form a loop, so that the heating wire connected to the conductive columns is electrified and heated; under the action of the heating wire, the smoke generating liquid is heated to a boiling point temperature, so that physical and chemical reactions are carried out to generate smoke; the liquid input port is closed, and generated smoke is discharged from the smoke outlet by adding certain pressure to the gas inlet.

In the description of the present disclosure, the description referring to “one embodiment”, “preferably”, “examples”, “specific example”, or “some examples” means that specific features, structures, materials or characteristics described in combination with the embodiment or example is included in at least one embodiment or example of the present disclosure. Illustrative expression for the above terms in the present specification does not necessarily refer to the same embodiment or example. Moreover, the described specific features, structures, materials or characteristics can be combined in any of one or more embodiments or examples appropriately.

Through the above description of the structure and the principle, it should be understood by those skilled in the art that the present disclosure is not limited to the above specific implementation mode, and improvement and substitution of prior art in the field on the basis of the present disclosure fall within the protection scope of the present disclosure and should be defined by the claims.

What is claimed is:

1. A smoke generator, comprising a shell, conductive columns, a heating resistance wire and cellucotton, wherein the conductive columns are connected with the heating resistance wire, and the cellucotton is in contact with the heating resistance wire;
an accommodating cavity is formed in the shell, and the cellucotton is placed in the accommodating cavity; a liquid input port, a gas inlet and a smoke outlet are formed in the shell, and the liquid input port, the gas inlet and the smoke outlet communicate with the accommodating cavity.

2. The smoke generator according to claim 1, wherein the shell is internally provided with a liquid level identification line.

3. The smoke generator according to claim 1, wherein the conductive columns comprise a first conductive column and a second conductive column, and the two ends of the heating resistance wire are respectively connected to the first conductive column and the second conductive column.

4. The smoke generator according to claim 1, wherein the cellucotton is vertically arranged along the accommodating cavity.

5. The smoke generator according to claim 3, wherein the length of the first conductive column is greater than that of the second conductive column.

6. The smoke generator according to claim 1, wherein the heating resistance wire is spirally wound on the cellucotton.
